(19) United States
(12) Patent Application Publication
(10) Pub. No.: US 2007/0225022 A1
(43) Pub. Date: Sep. 27, 2007

(54) Mobile Terminal, Method for Controlling Mobile Telephone Terminal, and Mobile Telephone Terminal

(75) Inventor: Masaomi Satake, Tokyo (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi (JP)

(21) Appl. No.: 11/756,345

(22) Filed: May 31, 2007

Related U.S. Application Data
(62) Division of application No. 11/040,061, filed on Jan. 20, 2005.

(30) Foreign Application Priority Data
Jan. 27, 2004 (JP) 2004018342
Jan. 27, 2004 (JP) 2004018343

(51) Int. Cl. H04Q 7/20

(52) U.S. Cl. 455/466

(57) ABSTRACT

A mobile terminal that can execute a plurality of application programs in parallel, including a selection unit that prompts a user to select whether or not to quit an application program when a screen of the application program that is displayed is being switched to a screen of another application program.

### BACKGROUND OF THE INVENTION

1. Field of the Invention

The present invention relates to a mobile terminal, such as a mobile telephone terminal, that can execute multiple application programs in parallel. The present invention also relates to a method for controlling a mobile telephone terminal and a mobile telephone terminal that can execute multiple application programs, including a program that handles a telephone function, and can display an application program that is running on a screen.

Priority is claimed on Japanese Patent Application Nos. 2004-18342 and 2004-18343, filed Jan. 27, 2004, the contents of which are incorporated herein by reference.

2. Description of Related Art

A conventional mobile telephone terminal that can execute multiple application programs (hereinafter referred to as “application”), including an application that handles a telephone function, has a very small display area due to the size constraints of mobile terminals. Only a single application is displayed on a display of such a mobile telephone terminal because the display cannot accommodate screens of multiple applications. In general, when multiple applications are executed simultaneously, only one of these applications is displayed and the rest remain running in the background.

In a conventional mobile telephone terminal, when a user switches from a screen of one application to that of another application, the application previously displayed remains running until the user instructs to quit the program.

Japanese Unexamined Patent Application, First Publication No. 2003-319020 discloses a mobile terminal that can contain applications.

However, mobile telephone terminals generally have a CPU (central processing unit) with limited processing power and a smaller amount of memory compared to personal computers. Thus, if multiple applications are executed simultaneously on a mobile telephone terminal, the operation or display of the screen may be delayed, or in a worst case scenario, the mobile telephone terminal may not respond to a user's manipulation at all (hereinafter, such a state is referred to as a “freeze”).

Furthermore, when a mobile telephone terminal is within a coverage area of a base station while it is turned on, the user of the mobile telephone terminal expects that the mobile phone can receive an incoming call or make an outgoing call any time when desired. However, such a freeze not only prevents the user from receiving to incoming calls or placing outgoing calls, but also incapacitates other functions of the mobile telephone terminal.

Furthermore, in some of recent mobile telephone terminals that can execute multiple application programs, when an incoming email or call arrives while an application is being executed (displayed), a mobile phone needs to quit the application to switch to a talk screen. After the call is completed, the user has to start the application once again because a main menu screen is displayed automatically once the call ends. Alternatively in other mobile telephone terminal, when an incoming email or call arrives, the application is automatically paused to automatically switch to a talk screen. After the call ends, the user, therefore, desires to be able to go back from the main menu screen to the application screen that was displayed before the call arrives.

Methods for handing an incoming call while an application is executed have been proposed, and one such technique is described in Japanese Unexamined Patent Application, First Publication No. 2003-319020. in the technique disclosed in Japanese Unexamined Patent Application, First Publication No. 2003-319020, a PICT area is provided in a screen in order to notify a user of an incoming call and to display information related to the call, including the caller's name. When the user depresses an ANSWER key, the execution of the application is paused and a talk screen is displayed. After the call ends, the application screen is automatically displayed.

In conventional mobile telephone terminals, when an incoming call or mail arrives while an application, such as an email program, a movie player, a web browser, or a scheduler, is executed, the application is paused, as described above. After the call ends or the user finishes reading the email, the application is resumed. However, there is a need to keep an application displayed and to enable an operation of the application when a user answers an incoming call while the application is executed.

The method descried in the above-mentioned Japanese Unexamined Patent Application, First Publication No. 2003-319020 automatically switches the screen to an incoming call screen to answer an incoming call that arrives while the application is executed. However, it does not support display or operation of an application while on call.

### SUMMARY OF THE INVENTION

A first aspect of the present invention is directed to a mobile terminal that can execute multiple applications with which a user can select an operation for an application which had been displayed previously when the screen is switched from the application to another application, thereby reducing the processing load of the CPU and saving memory space, as well as preventing reduction in usability and display speed.

A mobile terminal according to the first aspect of the present invention is a mobile terminal that can execute a plurality of application programs in parallel, including a selection unit that prompts a user to select whether or not to quit an application program when a screen of the application program that is displayed is being switched to a screen of another application program.

Furthermore, a mobile terminal according to the first aspect of the present invention is a mobile terminal that can execute a plurality of application programs in parallel, including a selection unit that prompts a user to select whether or not to pause an application program when a screen of the application program that is displayed is being switched to a screen of another application program.

Furthermore, a mobile terminal according to the first aspect of the present invention is a mobile terminal that can execute a plurality of application programs in parallel, including a selection unit that prompts a user to select whether or not to quit an application program when another application program is being started while a screen of the application program is displayed.

Furthermore, a mobile terminal according to the first aspect of the present invention is a mobile terminal that can execute a plurality of application programs in parallel, including a selection unit that prompts a user to select whether or not to pause an application program when another application program is being started while a screen of the application program is displayed.

Furthermore, a mobile terminal according to the first aspect of the present invention is a mobile terminal that can execute a plurality of application programs in parallel, including a selection unit that displays a list of the plurality of applications currently executed and enables a user to select one of the plurality of application programs to quit in the screen when another application program is being started while a screen of an application program displayed.

According to the first aspect of the present invention, the processing load of the CPU is reduced, the memory space is saved, and a deterioration of usability and the display speed is prevented in the mobile terminal.

A second aspect of the present invention is directed to a method that enables display and an operation of an application after an incoming call that arrives while the application is executed.

A method for controlling a mobile telephone terminal according to the second aspect of the present invention includes the steps of: when a screen of an application is displayed, notifying of an arrival of an incoming call with the screen of the application program being displayed; and allowing answering to the incoming call with the screen of the application program being displayed if a user selects to answer to incoming call while notifying of the incoming call.

Furthermore, a mobile telephone terminal according to the second aspect of the present invention includes a display unit for, when a screen of an application is displayed, notifying of an arrival of an incoming call with the screen of the application program being displayed; an operation unit for answering the incoming call with the display unit notifying an arrival of the incoming call; and a control unit for enabling to talking on the mobile telephone terminal with the screen of the application program being displayed if the incoming call is received by the operation unit.

In the mobile telephone terminal according to the second aspect of the present invention, the control unit may place the mobile telephone terminal to a hands-free mode if the incoming call is received by the operation unit.

The mobile telephone terminal according to the second aspect of the present invention may further include a display unit for displaying detailed information on a caller of the incoming call with the screen of the application program being displayed.

According to the second aspect of the present invention, when an incoming call arrives while an application is executed, a user can answer the incoming call or placing an outgoing call while viewing the application screen. In addition, the user can operate the application while talking over the call.

### BRIEF DESCRIPTION OF THE DRAWINGS

FIG. 1 is a block diagram illustrating a structure of a mobile telephone terminal according to an embodiment of the present invention.

FIG. 2 is a schematic diagram of a task list.

FIG. 3 is a plan view illustrating a mobile telephone terminal according to an embodiment of a first aspect of the present invention.

FIG. 4 is a schematic diagram of a user selection screen.

FIG. 5 is a flow chart illustrating one example of the operation of application switching according to a first embodiment of the first aspect of the present invention.

FIG. 6 is a flow chart illustrating an alternative operation of application switching according to the first embodiment of the first aspect of the present invention.

FIG. 7 is a flow chart illustrating one example of the operation of application switching according to a second embodiment of the first aspect of the present invention.

FIG. 8 is a flow chart illustrating one example of the operation of application switching according to a third embodiment of the first aspect of the present invention.

FIG. 9 is flow chart illustrating one example of the operation of application switching according to a fourth embodiment of a first aspect of the present invention.

FIG. 10 is a schematic diagram illustrating one example of a screen during the operation of application switching according to the fourth embodiment of the first aspect of the present invention.

FIG. 11A is a plan view illustrating a mobile telephone terminal according to an embodiment of a second aspect of the present invention.

FIG. 11B is a rear view illustrating a mobile telephone terminal according to an embodiment of the second aspect of the present invention.

FIG. 12 is a diagram illustrating an example of transition of screens when an incoming call arrives according to a prior art.

FIG. 13 is a diagram illustrating a specific example of the transition of screens using icons according to a first embodiment of the second aspect of the present invention.

FIG. 14 is a diagram illustrating a specific example of the transition of screens using split screens according to a second embodiment of the second aspect of the present invention.

FIG. 15 is a diagram illustrating a specific example of the transition of screens using icons according to a third embodiment of the second aspect of the present invention.

### DETAILED DESCRIPTION OF THE INVENTION

First Aspect

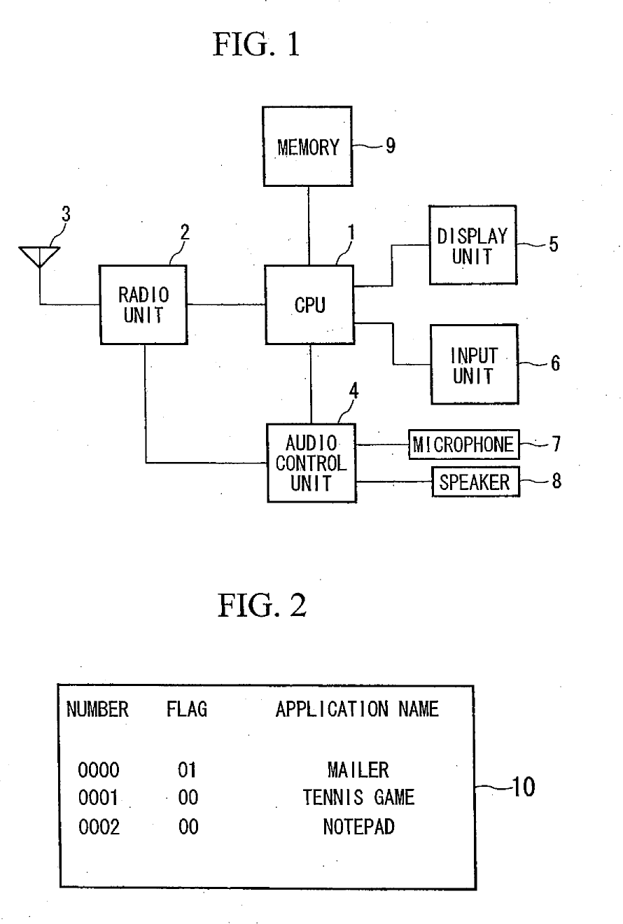

In the following, various embodiments according to a first aspect of the present invention will be explained with reference to the drawings. FIG. 1 is a block diagram illustrating a structure of a mobile telephone terminal, as an example of a mobile terminal according to the first embodiment of the first aspect of the present invention. This mobile telephone terminal is controlled by a CPU 1, and includes a radio unit 2, an antenna 3, an audio control unit 4, a display unit 5, an input unit 6, a microphone 7, a speaker 8, and a memory 9. The antenna 3 is connected to the radio unit 2, and sends to and receives from a base station a radio signal. The received signal is handled by the audio control unit 4, and a corresponding sound is then output from the speaker 8. An audio signal input from the microphone 8 is sent to the radio unit 2 via the audio control unit 4, and sent to the base station via the antenna 3. The memory 9 stores application programs, input data, telephone numbers and email addresses, and schedules as well as a task list 10 maintained by the CPU 1. An example of the task list 10 is shown in FIG. 2.

The task list 10 shown in FIG. 2 contains rows each corresponding to an application currently running or paused in the mobile terminal. Each row includes three fields, and a respective field contains a display order, a flag that indicates whether the application is executed or paused, and the name of the application. In the list, applications are sorted according to the usage history, and the application that was most recently displayed tops the list. The values of “00” and “01” of the flag indicate that the application is paused, and that the application is running, respectively.

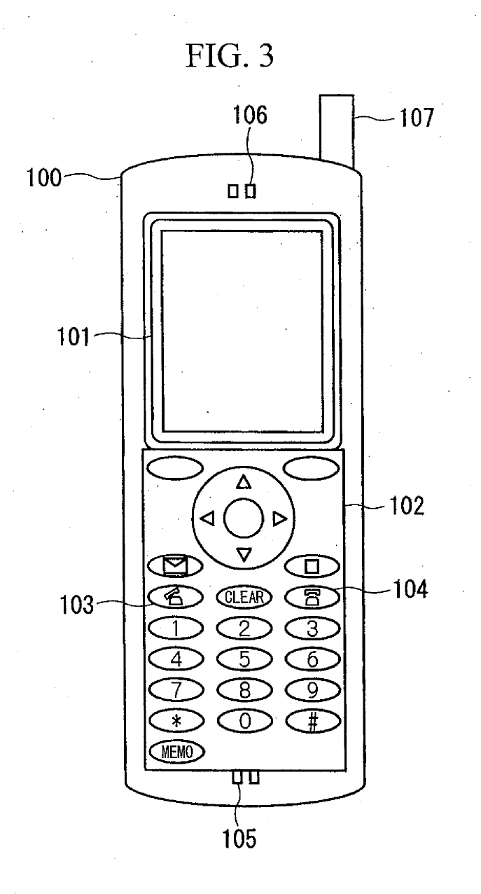

FIGS. 3 is a plan view of a mobile telephone terminal. The mobile telephone terminal 100 includes a display screen 101, a key input unit 102, an ANSWER key 103, a HANG-UP key 104, a microphone 105, a speaker 106, and an antenna 107. The display screen 101 can display a screen of an application and the status of the call function, and a user can operate the application via the key input unit 102. The key input unit 102 includes keys such as the ANSWER key 103 and the HANG-UP key 104, and a user can make a telephone call by entering a telephone number from the key input unit 102 and depressing the ANSWER key 103. The user can then hang up the call by depressing the. HANG-UP key 104.

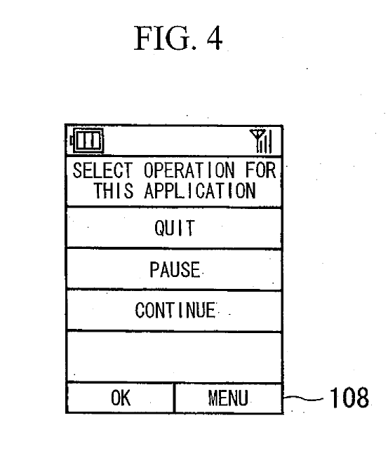

The display screen 101 also displays a user selection screen 108 shown in FIG. 4 with which a user can switch applications. The user selection screen 108 is a screen with which a user can select the operation performed on the application currently displayed on the display screen when switching applications. As shown in the figure, the user can select either one of “QUIT,” “PAUSE,” and “CONTINUE”.

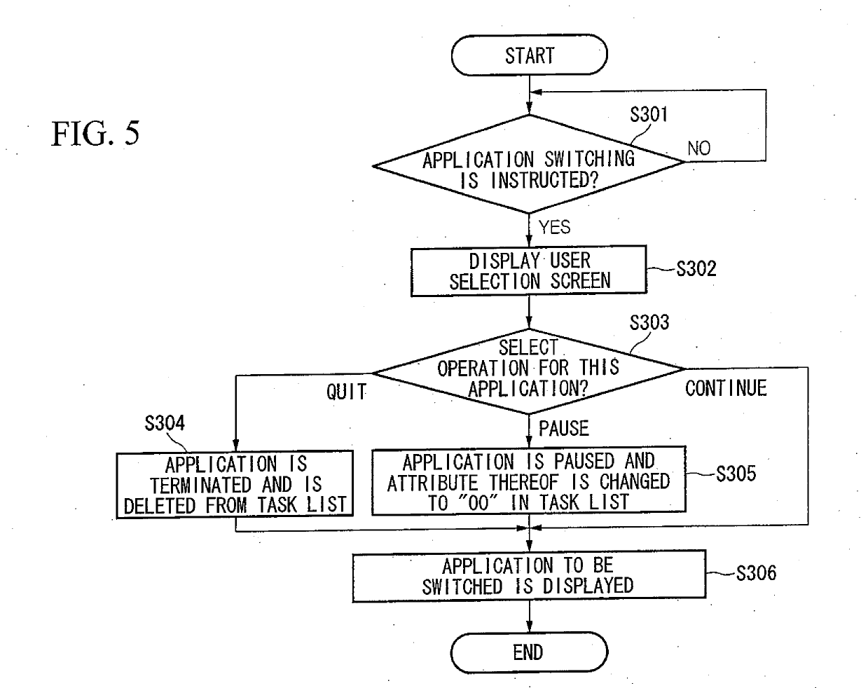

FIG. 5 is a flow chart illustrating an operation of the application switching. When an application switching is instructed while multiple applications are executed in step S301, the user selection screen 108 is displayed in step S302, and the user is prompted to choose an operation to be performed on the application that is currently displayed in step S303. If the user selects “QUIT,” the application is terminated and an entry corresponding to the terminated application is deleted from the task list 10 in step S304. If the user selects “PAUSE,” the application is paused and the flag indicating the attribute of the application is changed to “00” in the task list 10 in step S305. If the user selects “CONTINUE,” the application is continued to be executed. In the manner described above, when the user selects “QUIT,” or “PAUSE, ” or “CONTINUE” in the user selection screen 108, the application to be switched is displayed in step S306.

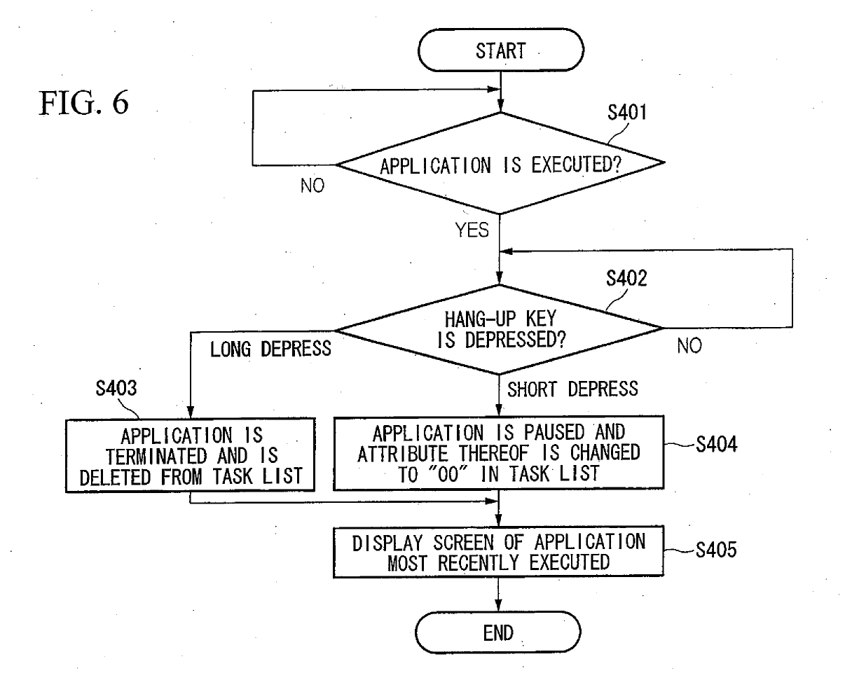

FIG. 6 is a flow chart illustrating an alternative operation of the application switching While an application is executed in step S401, the user depresses the HANG-UP key 104 in step S402. If the user depresses the HANG-UP key 104 for a time period equal to or longer than a certain period of time (long depress), application is terminated and an entry corresponding to the terminated application is deleted from the task list 10 in step S403. If the user depresses the HANG-UP key 103 for a time period shorter than the certain period of time (short depress), the application is paused and the flag indicating the attribute of the application is changed to “00” in the task list 10 in step S404. If the HANG-UP key 104 has been long-depressed or short-depressed by the user, a standby screen or the screen of the application that was displayed before the application switch is instructed is displayed instead of the screen of the current application in step S405. If the user depresses the HANG-UP key 104, nothing will happen. Therefore, the user can switch applications while keeping the current application executed by following the operation of switching applications. As used herein, the term “pause” refers to temporarily stopping the progress of the application that progresses according to time. Examples of such application includes, for example, games, and music or movie players.

According to this embodiment, a display is switched from a screen of one application to that of another application, the user can select either to quit or to pause the application that has been displayed right before the switching operation was instructed. If the user selects to quit the application, the process of the application is terminated and the memory space is freed, thereby reducing the load of the CPU and saving the memory space. If the user selects to pause the application that has been displayed right before the switching operation was instructed, the application is paused and the screen is switched to a screen of a second application. When this second application ends, the application which had been displayed previously can be resumed automatically. For example, if the user switched to the screen of another application while playing a car-racing game application, the user can pause the car-racing game application and resume the game automatically if the second application ends. In addition, putting an application into resume can reduce the load of the CPU, although the memory space is not freed.

In addition, keys for quitting or pausing an application may be provided and the application may be quit or paused by a user who long- or short-depresses the key. Thus, the user can quit or pause an application easily and quickly to switch to another application by long- or short-depressing the key while the application is executed.

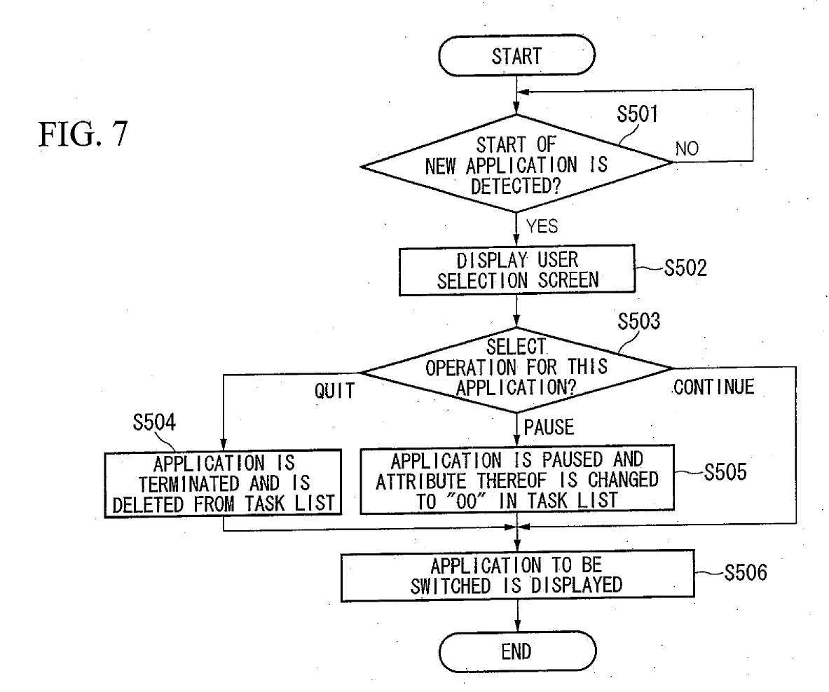

Next, a second embodiment of the first aspect of the present invention will be explained with reference to the flowchart of FIG. 7.

It is notified that a new application was started while an application is executed in step S501. The user selection screen 108 is displayed in step S502, and the user is prompted to choose an operation to be performed on the application that is currently displayed in step S503. When the user selects “QUIT,” the application is terminated and an entry corresponding to the terminated application is deleted from the task list 10 in step S504. If the user selects “PAUSE,” the application is paused and the flag indicating the attribute of the application is changed to “00” in the task list 10 in step S505. If the user selects “CONTINUE,” the application is continued to be executed. In the manner described above, when the user selects either “QUIT,” “PAUSE, ” or “CONTINUE” in the user selection screen 108, the new application is displayed in step S506.

According to this embodiment, when a user starts a new application while another application is executed, the user can select either to quit or to pause the application that has been displayed right before the switching operation was instructed. If the user selects to quit the old application, the load of CPU can be reduced and the memory space can be saved. If the user selects to pause the application that has been displayed right before the new application was started, the application is paused and the screen is switched to a screen of the newly started application. If the new application ends, the application which had been displayed previously can be displayed automatically. In addition, putting an application into resume can reduce the load of the CPU, although the memory space is not freed.

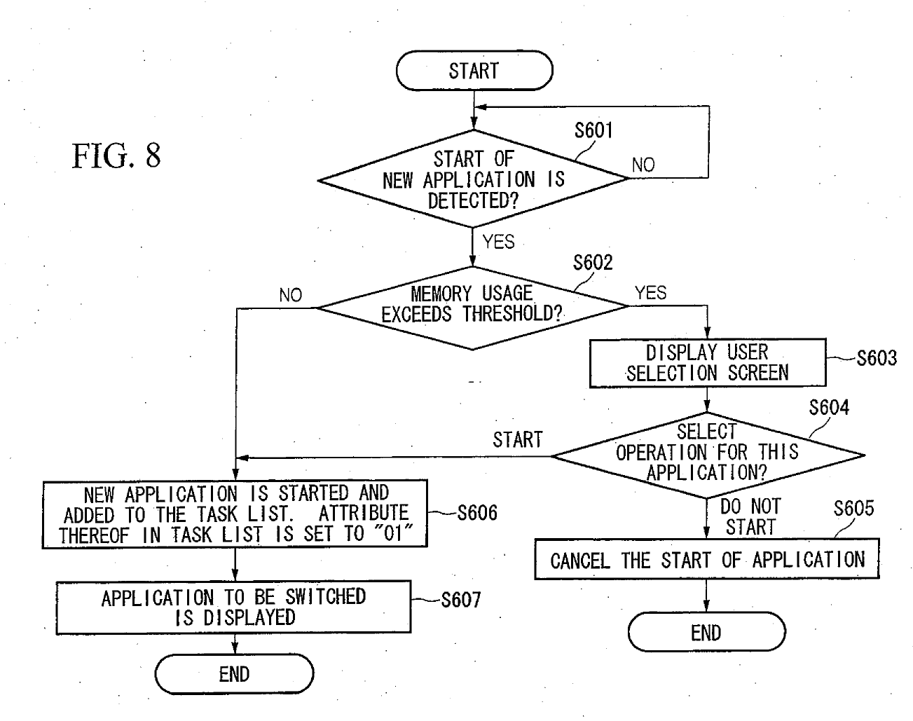

Next, a third embodiment of the first aspect of the present invention will be explained with reference to the flowchart of FIG. 8.

When it is notified that a new application was started while an application is executed in step S601, it is determined whether or not the current usage of the memory exceeds a certain threshold to start an application in step S602. If the current usage of the memory exceeds the threshold, the user selection screen is displayed in step S603, and the user is prompted to choose an operation to be performed on the new application in step S604. If the user selects “DO NOT START,” the start of the new application is cancelled in step S605.

If the user chooses “START,” the new application is started and added to the task list 10. After The attribute of the task list is set to “01” in step S606, the new application is displayed in step S607.

According to this embodiment, when a new application is started while an application is executed, the user is prompted to choose whether or not start the application considering memory usage required to start the application. Thus, freeze of the mobile terminal can be prevented by diverting the situation in which the memory usage reaches the maximum.

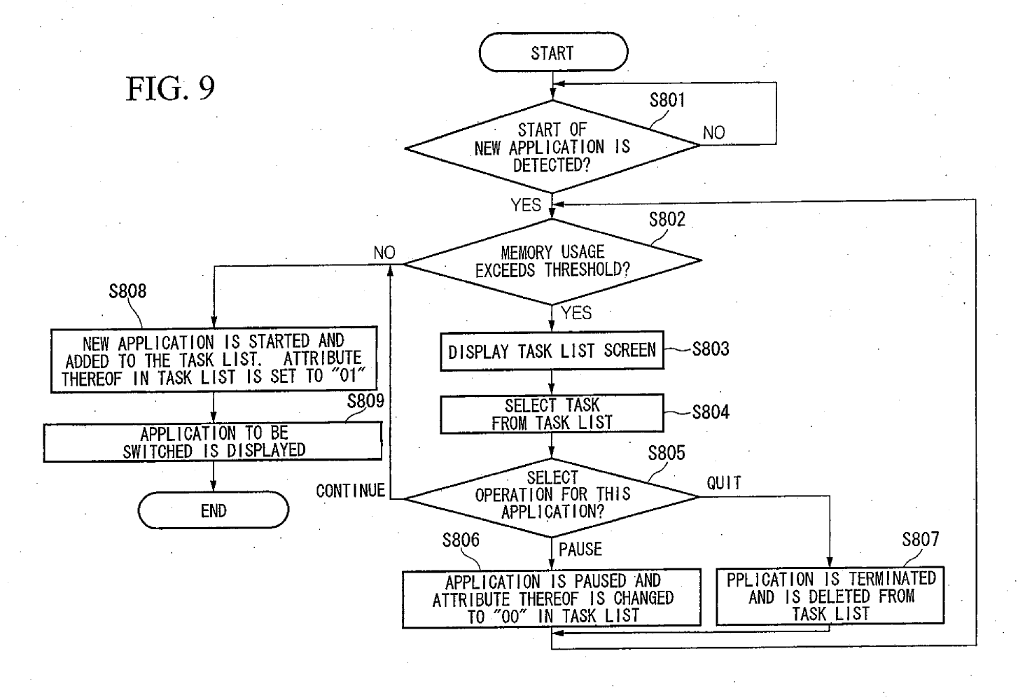

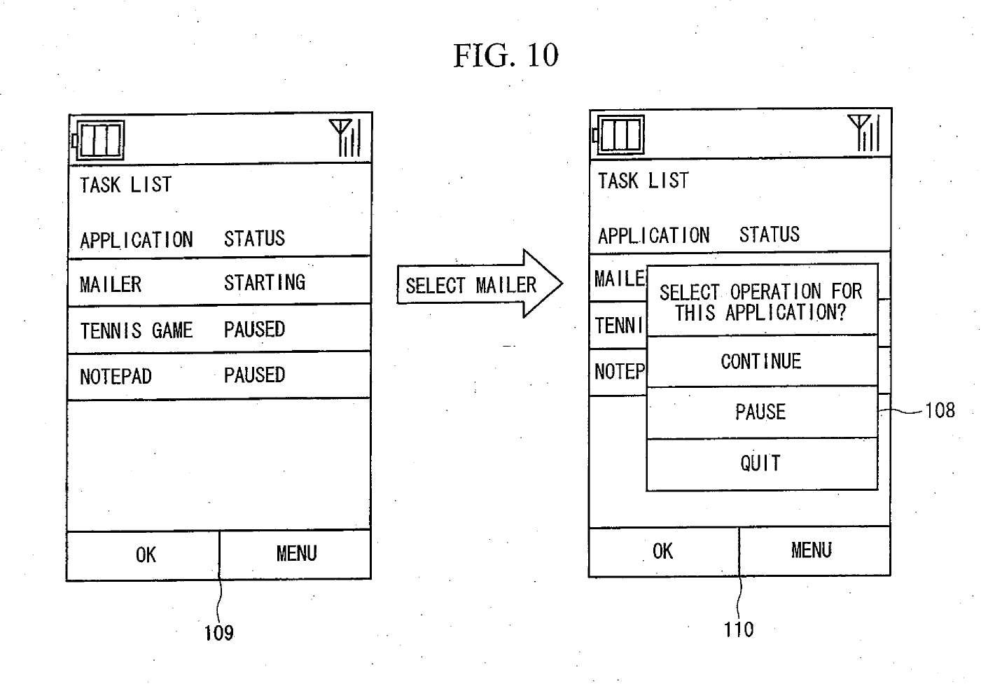

Next, a fourth embodiment of the first aspect of the present invention will be explained with reference to the flowchart of FIG. 9. When it is notified that a new application was started while an application is executed in step S801, it is determined whether or not the current usage of the memory exceeds a certain threshold to start an application in step S802. If the current usage of The memory exceeds the threshold, the task list screen 109 shown in FIG. 10 is displayed in step S803 to prompt the user to select a task from tasks listed in the task list screen 109 in step S804, for example. The user then prompted to select the operation for the selected application from the user selection screen 108 in step S805. When the user selects “QUIT,” the selected application is terminated and the corresponding entry is deleted from the task list screen 109. Then the flow returns to step S802 in step S807 when the user selects “PAUSE,” the selected application is paused and the attribute of the corresponding entry is set to “00” in The task list screen 109. Then the flow returns to step S802 in step S807. If the user select “CONTINUE,” and the memory usage does not exceed the threshold in step S802, the new application is started and a corresponding entry is added to the task list screen 109. The attribute of the task list is set to “01” in step S809, and the new application is displayed in step S809.

According to this embodiment, when a new application is started while an application is executed, the user is prompted to choose whether or not start the application taking memory usage required to start the application. Thus, memory consumption can be reduced into account. Furthermore, when a large amount of the memory is used, a user can select an application that is quit or paused until the memory usage reaches to an appropriate value. Thus, an effective use of the memory can be realized.

It should be noted that in the present invention, the term “executing multiple applications” means that “the multiple applications are executed in parallel.” The term also includes the situation in which only one of the multiple programs is executed in a very short time period and another program is executed thereafter and so forth, although this is not exactly a true “simultaneous execution.” In the latter case, the CPU time is divided into a very short time period and the divided CPU time is allocated to the multiple application software in order, as if multiple applications are executed at the same time.

The scope of the mobile terminal of the present invention extends to mobile telephone terminals and personal digital assistants (PDA), and the like.

Second Aspect

In the following, various embodiments according to a second aspect of the present invention will be explained with reference to the drawings.

FIG. 1 is a block diagram illustrating a structure of a mobile telephone terminal according to the second aspect of the present invention.

The scope of the mobile telephone terminal of the present invention extends to mobile telephones and personal digital assistants (PDA), and the like.

A cellular phone terminal according to this embodiment is controlled by a CPU 1, and includes a radio unit 2, an antenna 3, an audio control unit 4, a display unit 5, an input device 6, a microphone 7, a speaker 8, and a memory 9. The antenna 3 is connected to the radio unit 2, and sends to and receives from a base station a radio signal. The received signal is handled by the audio control unit 4, and a corresponding sound is then output from the speaker 8. An audio signal input from microphone 7 is sent to the radio unit 2 via the audio control unit 4, and sent to the base station via the antenna 3. The memory 9 stored application input data, telephone numbers, email addresses, schedules and the like.

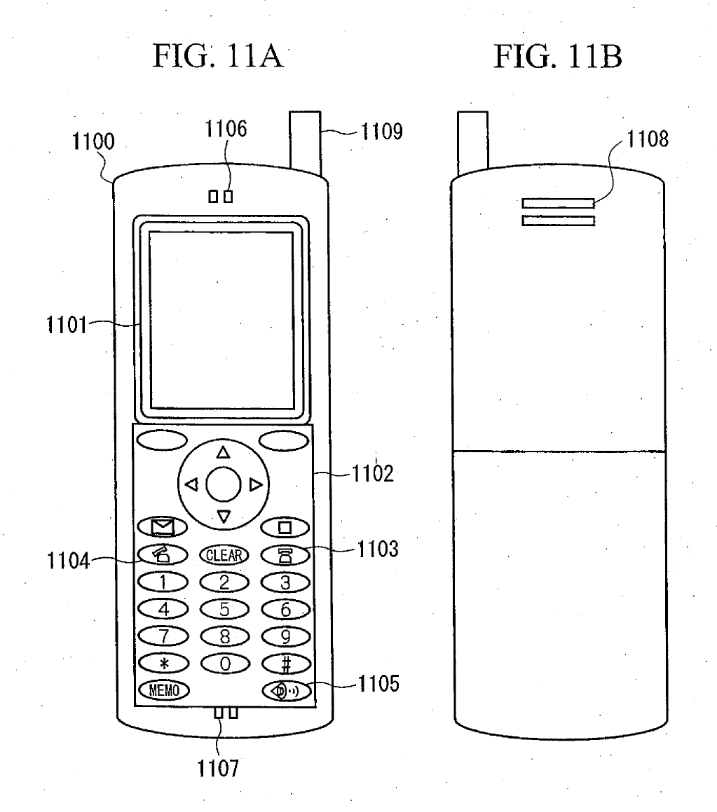

FIGS. 11A to 11B are a plan view and a back view of a mobile telephone terminal, respectively.

The cellular phone terminal 1100 includes a display screen 1101, a key input device 1102, a HANG-UP key 1103, a ANSWER key 1104, a HANDS-FREE key 1105, a speaker 1106, a microphone 1107, a loudspeaker 1108, and an antenna 1109.

The display screen 1101 can display an application and status of communications function, and a user can operate the application via the key input device 1102. The key input device 1102 includes the HANG-UP key 1103, the ANSWER key 1104, and the HANDS-FREE key 1105, and a user can make a telephone call by entering a telephone number via the key input device 1102 and depressing the ANSWER key 1104. The user can then hang up the call by depressing the HANG-UP key 1103. The HANDS-FREE key 1105 allows a user to answer or place a call while a screen of an application is displayed, as well as to place the mobile telephone terminal to a hands-free mode. When the HANDS-FREE key 1105 is depressed while placing or answering a call, the cellular phone terminal is placed into the hands-free mode while the application screen is displayed.

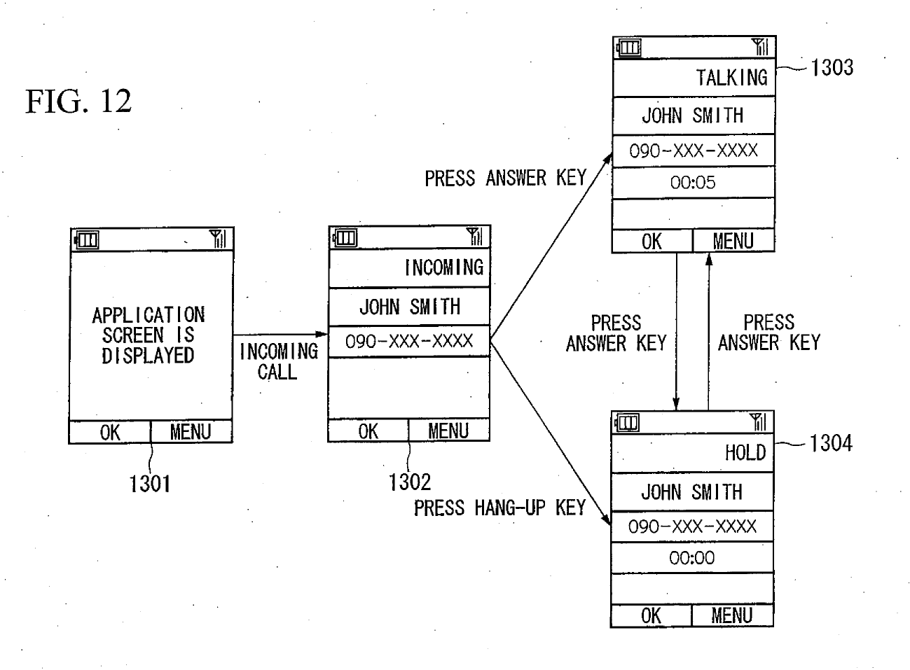

FIG. 12 is a diagram illustrating an example of transition of screens when an incoming call arrives according to a prior art.

An application executing screen 1301 is displayed when a user is operating an application. When an incoming call arrives while the application executing screen 1301 is displayed, the screen is switched to an incoming call screen 1302 and the application the user was operating is automatically quit or paused. When the ANSWER key is depressed while the incoming call screen 1302 is displayed, a talk screen 1303 is displayed so as to answer the call. When the HANG-UP key is depressed, a hold screen 1304 is displayed and the call is put on hold. The only information displayed regarding the call is information displayed on the talk screen 1303 or on the hold screen 1304, and the application that was executed will not be displayed or cannot be operated until this call ends.

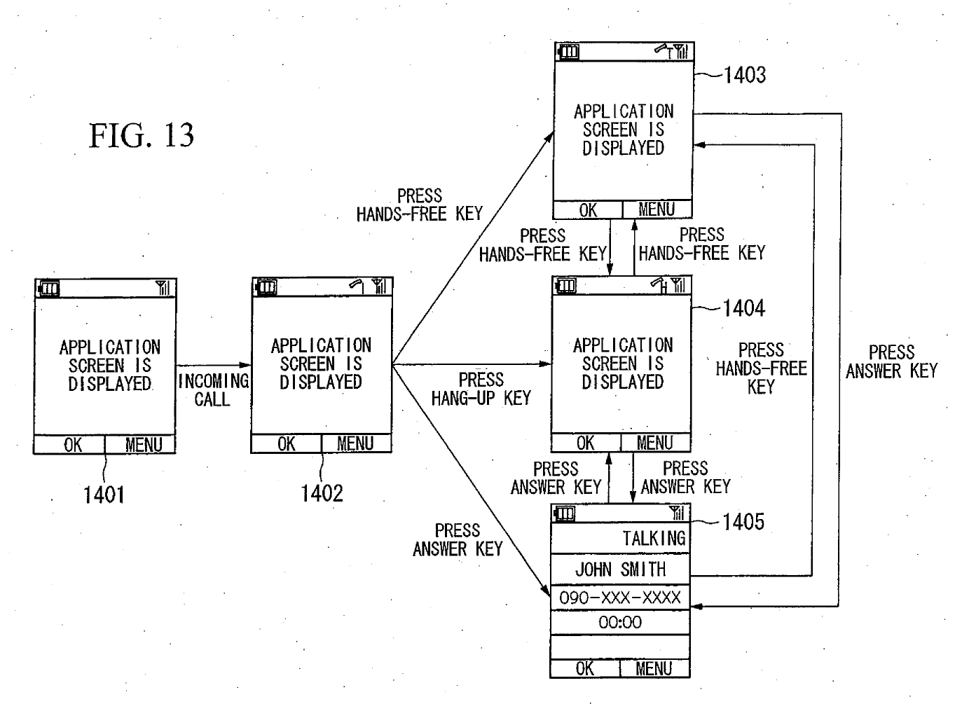

FIG. 13 is a diagram illustrating a specific example of the transition of screens using icons according to a first embodiment of the second aspect of the present invention.

An application executing screen 1401 is displayed when an application is started and displayed, and a user can operate the application using this screen. When an incoming call arrives while the application executing screen 1401 is displayed, the screen is switched to an application executing during call incoming screen 1402. The application executing during call incoming screen 1402 displays an incoming call icon (in the figure, an icon of handset and a letter “I” are displayed) in a PICT area at the top of the screen, as well as the application screen. In this example, an application with audio is executed, for example, a game, a movie, a TV, or a radio player, the audio is output.

When the HANDS-FREE key 1105 is depressed while application executing during call incoming screen 1402 is displayed, the mobile telephone terminal is placed into a hands-free mode. The screen is changed to an application executing during calling screen 1403 in which both an operation of the application and making or answering calls are available while running and displaying the application. In the hands-free mode, the device that outputs an audio is switched from the speaker 1106 to the loudspeaker 1108. If an application with audio is executed, for example, a game or a movie player, the audio is output from the loudspeaker 1108 as well as the voice of the caller. The icon in the PICT area at the top of the screen is changed from the incoming call icon to a talking icon (in the figure, an icon of handset and a letter “T” are displayed).

When the ANSWER key 1104 is depressed while the application executing during call incoming screen 1402 is displayed, a conventional talk screen 1405 is displayed. This mode is a hand-set mode in which a voice of the caller is output from the speaker 1106.

When the HANG-UP key 1103 is depressed while the application executing during call incoming screen 1402, the call is put on hold and the display is changed to a call hold screen 1404. If an application with audio is executed, for example, a game or a movie player, the audio is output as well as the screen of the application is displayed. The icon on the PICT area at the top of the screen is switched from the incoming call icon to a hold icon (in the figure, an icon of handset and a letter “H” are displayed).

When the ANSWER key 1104 is depressed while the application executing during calling screen 1403 is displayed, the screen is changed to the talk screen 1405 and the mobile telephone terminal is switched from the hands-free mode to the hand-set mode.

When the HANDS-FREE key 1105 is depressed while the application executing during calling screen 1403 is displayed, the call is put on hold and the screen is switched to the call hold screen 1404.

When the ANSWER key 1104 is depressed while the call hold screen 1404 is displayed, the display is changed to the conventional talk screen 1405, and if the HANDS-FREE key 1105 is depressed, the display is changed to the application executing during calling screen 1403.

When the ANSWER key is depressed when the talk screen 1405 is displayed, the display is changed to the application executing hold screen 1404.

When the HANDS-FREE key 1105 is depressed while the talk screen 1405 is displayed, the mobile telephone terminal is placed into a hands-free mode, and the display is changed to the application executing during calling screen 1403.

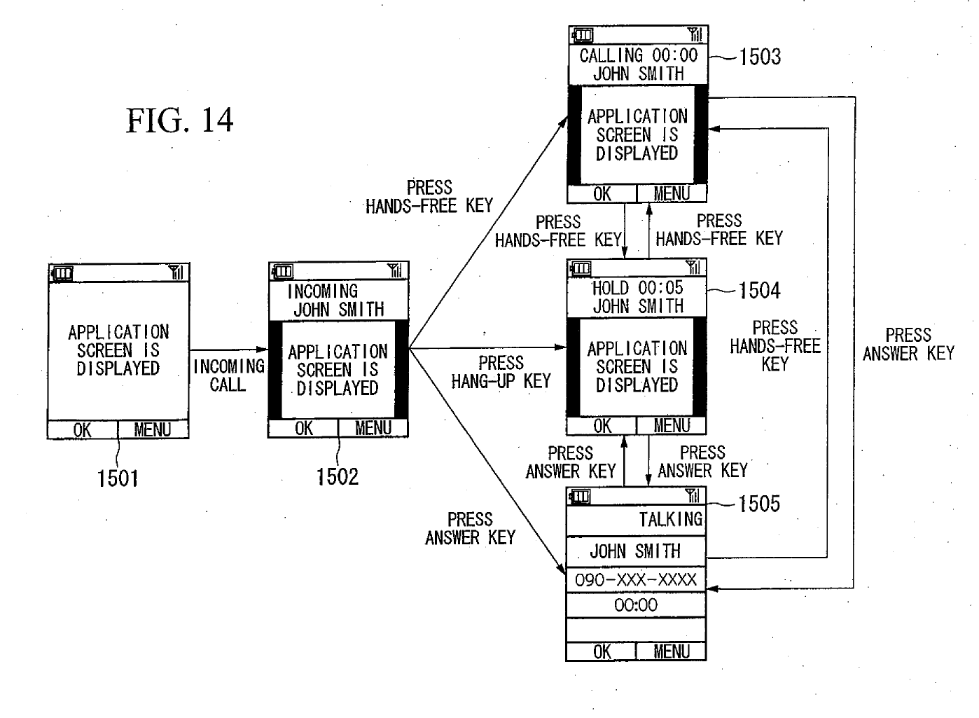

FIG. 14 is a diagram illustrating a specific example of the transition of screens using split screens according to a second embodiment of the second aspect of the present invention.

The design of the application executing screen is changed in examples shown in FIG. 14, and screen 1502, 1503, and 1504 correspond to the screens 1402, 1403, and 1404 in FIG. 13, respectively.

In this embodiment, instead of the icons in FIG. 11, shrunk versions of application display screen are displayed the in the screen 1502, 1503, and 1504, and the caller's name and the characters representing the status of the call (incoming, talking, or on hold) are displayed on the rest of the screen. The operations to switch screens are the same as those of the example shown in FIG. 11, and the description thereof is omitted.

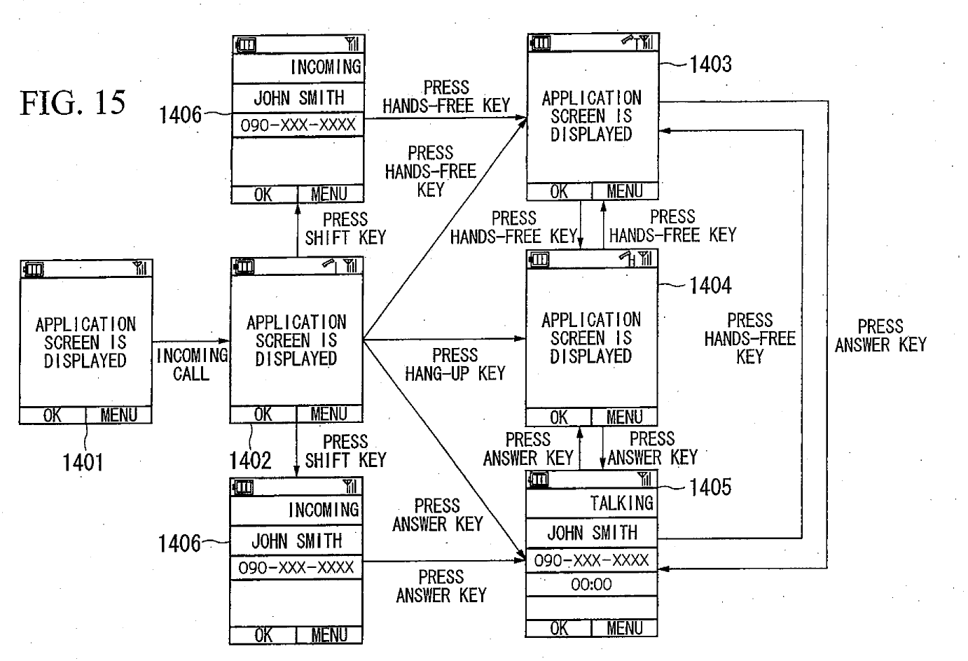

FIG. 15 is a diagram illustrating a specific example of the transition of screens using icons according to a third embodiment of the second aspect of the present invention.

In the first embodiment shown in FIG. 13, a user cannot know who the caller is from the screen 1402.

In this embodiment, the incoming call screen 1406 is displayed when the screen 1402 is switched to the screen 1403, and when the screen 1402 is switched to the screen 1405. A predetermined key in the key input device 1102 is used as a shift key that is used to switch from the screen 1402 to the incoming call the screen 1406. Because the caller's name is displayed in the incoming call the screen 1406, the user can decide either to display the screen 1403 by depressing the HANDS-FREE key 1105, or to display the screen 1405 by depressing the ANSWER key 1104 after the user confirms who the caller is.

It should be noted that the incoming call the screen 1406 may be displayed when the screen is switched from screen 1402 to the screen 1404, and vice versa.

Furthermore, the incoming call the screen 1406 may be displayed between the screen 1502 and one or more the screens 1503, 1504, and 1505 in the example shown in FIG. 14.

The second aspect of the present invention may be advantageous for the following reasons.

It is possible to answer an incoming call with an application being running and a screen of the application being displayed. When the user is, for example, accessing the Internet and checking a web page that offers information that the user needs, an incoming call arrives. The user can answer the incoming call by depressing a key that has been assigned as a key for answering calls with an application being displayed on a screen. The user can talk on the mobile telephone terminal while continuing checking the web page, with the Internet being connected without the Internet connection being paused. Or when the user is taking photos with a camera-mounted mobile telephone terminal, the user can answer an incoming call and talk on the mobile telephone terminal without missing the best moment to take the picture. The user also can answer or place a call while running an application, such as an email program, a game, and a web browser, and operate the application.

In addition, the mobile telephone terminal can be put into the hands-free mode while the application is displayed, and the application is still displayed during the hands-free mode. Thus, a user can talk while operating the application.

Furthermore, a user can switch between an application screen and a talk screen while taking on the mobile telephone terminal in a case where an application is running. The mobile telephone terminal is automatically switched from the hands-free mode to the hand-set mode when the display is changed from the application screen to the talk screen. In addition, the mobile telephone is automatically switched from the hand-set mode to the hands-free mode when the display is changed from the talk screen to the application screen. Thus, an appropriate talk mode is automatically selected without users' intervention, and the usability of the mobile telephone terminal is enhanced.

Furthermore, a user can easily switch from the hands-free mode to the hand-set mode with a single key operation when, for example, the user cannot clearly hear the voice of the caller from the loudspeaker of the mobile terminal or does not want the people surrounding the user to hear what the caller says while the application screen is displayed. Or the user may desire to send a file stored in the mobile terminal when the talk screen is displayed, or to tell someone over the phone regarding information obtained via an application that is running on the mobile terminal. In such cases, it is ensured that the information from the application is communicated by placing the mobile telephone terminal into a hands-free mode with a single key operation. When the user answers a call while the application screen is displayed, the user can talk to the caller while viewing the application screen without requiring an earphone since the mobile terminal is automatically switched to the hands-free mode.

In addition, since icons representing the status of the call is displayed in the PICT area, the only a small area is required to show the status of the communication, and an application can be displayed at the relatively large area of the screen. Furthermore, the user can check the status of the mobile phone while viewing the application screen.

Also, since the size of the application screen is adjusted and a talk screen that is displayed and the resized application screen are displayed on the same screen while an application is executed, the user can check the status of the talk, e.g., duration of the talk, while operating the application. The application can be displayed and operated while preserving the advantages of conventional talk screens.

A user can switch to the incoming call screen 1406 by depressing a shift key when the application executing during call incoming screen 1402 is displayed. Thus, the user can decide either to put the mobile terminal to the hands-free mode while viewing the application, or the talk mode, or the hold mode after the user confirms who the caller is in the incoming call the screen 1406.

In the above-described embodiments, handling of calls is used to describe the present invention. The present invention may be used to handling of emails while one or more application is executed.

While preferred embodiments of the invention have been described and illustrated above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1-8. (canceled)

9. A method for controlling a mobile telephone terminal, comprising the steps of:
when a screen of an application is displayed, notifying of an arrival of an incoming call with the screen of the application program being displayed; and
allowing answering to the incoming call with the screen of the application program being displayed if a user selects to answer to incoming call while notifying of the incoming call.

10. A mobile telephone terminal, comprising:
a display unit for, when a screen of an application is displayed, notifying of an arrival of an incoming call with the screen of the application program being displayed;
an operation unit for answering the incoming call with the display until notifying an arrival of the incoming call; and
a control unit for enabling to talk on the mobile telephone terminal with the screen of the application program being displayed if the incoming call is answered by the operation unit.

11. The mobile telephone terminal according to claim 10, wherein the control unit places the mobile telephone terminal to a hands-free mode if the incoming call is answered by the operation unit.

12. The mobile telephone terminal according to claim 10, further comprising a display unit for displaying detailed information on a caller of the incoming call with the screen of the application program being displayed.
